(19) United States
(12) Patent Application Publication
(10) Pub. No.: US 2025/0261034 A1
(43) Pub. Date: Aug. 14, 2025

(54) Mobility Network Support for Scrubbed IP Domains

(71) Applicant: AT&T Intellectual Property I, L.P., Atlanta, GA (US)

(72) Inventors: Robert Chin, South Plainfield, NJ (US); Christopher Van Wart, Ocean, NJ (US)

(73) Assignee: AT&T Intellectual Property I, L.P., Atlanta, GA (US)

(21) Appl. No.: 18/441,074

(22) Filed: Feb. 14, 2024

(51) Int. Cl. H04W 28/02; H04W 8/18; H04W 12/088

(52) U.S. Cl. CPC H04W 28/0252; H04W 8/18; H04W 12/088

(57) ABSTRACT

Providing mobility network support for scrubbed IP domains can include obtaining packet forwarding control protocol messages associated with a mobility network, the packet forwarding control protocol messages relating to data communications of user equipment attached to the mobility network via a radio resource, correlating the packet forwarding control protocol messages to subscriber identities or device identities to obtain correlated packet forwarding control protocol messages, determining, based on the correlated packet forwarding control protocol messages, if the user equipment is associated with a malicious subscriber or comprises a malicious device, in response to determining that the user equipment is associated with a malicious subscriber or comprises a malicious device, selecting an interface via which the radio resource connects to a user plane of the mobility network, and triggering activation of an interface-located firewall on the interface to monitor data exchanged via the interface.

### BACKGROUND

With the increased prevalence of wireless networking and wireless Internet-enabled devices has come a corresponding increase in wireless network traffic and a corresponding increase in wireless-based attacks on networks. When malicious and/or harmful content or traffic is detected in a wireless network, network security may detect the malicious content and quarantine the content or otherwise neutralize any threat posed by the content or traffic. Such an approach, however, may be based on matching content or traffic to known patterns associated with viruses or the like. As attacks become more sophisticated and may rely on multiple devices and/or entities, recognizing and/or stopping malicious content and/or traffic may be difficult as the granularity required to detect such multi-actor attacks can be limited in wireless networks.

### SUMMARY

The present disclosure is directed to mobility network support for scrubbed Internet Protocol (hereinafter “IP”) domains. By applying scrubbed IP domain technologies to mobility networks in a new manner, shared connections that share a similar network address translation (“NAT”) scheme (i.e., NAT'ed IP addresses) can be filtered on a device-level (e.g., by IMEI, SUPI, or the like) and/or subscriber-level (e.g., by IMSI or the like) to identify specific devices or subscribers associated with malicious content or traffic. Previous technologies may be unable to provide such filtering.

Furthermore, embodiments of the concepts and technologies disclosed herein can enable a new firewall on an interface between radio resources of a mobility network and the user plane of the mobility network. Thus, for example, an interface-located firewall can be provided to apply firewall rules to traffic occurring via the interfaces (e.g., the N3interface of a 5G network and/or an S1-U interface of a 4G network), identify malicious activity, events, content, and/or traffic based on packet forwarding control protocol messages, take steps to block or allow devices or subscribers based on the identification, and to report device identifiers to the scrubbed IP domain service for further action.

With the use of intelligent monitoring of NAT'ed traffic leaving the user plane of the mobility network (e.g., the packet data network gateway user plane function/serving gateway user plane function of a fourth generation network along the SGi interface and/or the user plane function of a fifth generation network along the N6 interface), it can potentially be determined that certain parameters of UEs (e.g., some or all IMEIs of some vendor-type UEs have become part of a botnet that could potentially attack the scrubbed IP space) indicate a threat to the mobility network. It should be understood that this example embodiment is illustrative, and therefore should not be construed as being limiting in any way.

According to one aspect of the concepts and technologies disclosed herein, a system is disclosed. The system can include a processor and a memory. The memory can store computer-executable instructions that, when executed by the processor, cause the processor to perform operations. The operations can include obtaining packet forwarding control protocol messages associated with a mobility network. The packet forwarding control protocol messages can relate to data communications, which can relate to a user equipment that is attached to the mobility network via a radio resource of the mobility network. The operations further can include correlating the packet forwarding control protocol messages to subscriber identities or device identities to obtain correlated packet forwarding control protocol messages; determining, based on the correlated packet forwarding control protocol messages, if the user equipment is associated with a malicious subscriber or includes a malicious device; in response to determining that the user equipment is associated with a malicious subscriber or includes a malicious device, selecting an interface via which the radio resource connects to a user plane of the mobility network; and triggering activation of an interface-located firewall on the interface to monitor data exchanged via the interface.

In some embodiments the mobility network can include a fifth generation cellular network, the interface can include an N3 interface, the radio resource can include a gNodeB, and the user plane traffic can occur between at least two of the gNodeB, a user plane function, or a session management function that controls the user plane function. In some embodiments the mobility network can include a fourth generation cellular network, the interface can include an S1-U interface, the radio resource can include an eNodeB, and the user plane traffic can occur between at least two of the eNodeB, a serving gateway user plane function/packet data network gateway user plane function, or a serving gateway control plane function/packet data network gateway control plane function that controls the serving gateway user plane function/packet data network gateway user plane function.

In some embodiments the device identity can include an international mobile equipment identity or a subscription permanent identifier, and the subscriber identity can include an international mobile subscriber identity. In some embodiments the interface-located firewall can be configured via firewall rules to determine, based on the communications of the user equipment via the interface, if the user equipment should be blocked from communicating with the mobility network. In some embodiments in response to determining that the user equipment should be blocked from communicating with the mobility network, the interface-located firewall can report a device identifier associated with the user equipment to a scrubbed IP domain service that controls the interface-located firewall. In some embodiments the scrubbed IP domain service can obtain the packet forwarding control protocol messages associated with the interface, and the scrubbed IP domain service can send firewall rules to the interface-located firewall to control the interface-located firewall.

According to another aspect of the concepts and technologies disclosed herein, a method is disclosed. The method can include obtaining, by a computer including a processor, packet forwarding control protocol messages associated with a mobility network. The packet forwarding control protocol messages can relate to data communications that can relate to a user equipment that is attached to the mobility network via a radio resource of the mobility network. The method also can include correlating, by the processor, the packet forwarding control protocol messages to subscriber identities or device identities to obtain correlated packet forwarding control protocol messages; determining, by the processor and based on the correlated packet forwarding control protocol messages, if the user equipment is associated with a malicious subscriber or includes a malicious device; in response to determining that the user equipment is associated with a malicious subscriber or includes a malicious device, selecting, by the processor, an interface via which the radio resource connects to a user plane of the mobility network; and triggering activation of an interface-located firewall on the interface to monitor data exchanged via the interface.

In some embodiments the mobility network can include a fifth generation cellular network, the interface can include an N3 interface, the radio resource can include a gNodeB, and the user plane traffic can occur between at least two of the gNodeB, a user plane function, or a session management function that controls the user plane function. In some embodiments the mobility network can include a fourth generation cellular network, the interface can include an S1-U interface, the radio resource can include an eNodeB, and the user plane traffic can occur between at least two of the eNodeB, a serving gateway user plane function/packet data network gateway user plane function, or a serving gateway control plane function/packet data network gateway control plane function that controls the serving gateway user plane function/packet data network gateway user plane function.

In some embodiments the device identity can include an international mobile equipment identity or a subscription permanent identifier, and the subscriber identity can include an international mobile subscriber identity. In some embodiments the interface-located firewall can be configured via firewall rules to determine, based on the communications of the user equipment via the interface, if the user equipment should be blocked from communicating with the mobility network. In some embodiments in response to determining that the user equipment should be blocked from communicating with the mobility network, the interface-located firewall can report a device identifier associated with the user equipment to a scrubbed IP domain service that controls the interface-located firewall. In some embodiments the scrubbed IP domain service can obtain the packet forwarding control protocol messages associated with the interface, and the scrubbed IP domain service can send firewall rules to the interface-located firewall to control the interface-located firewall.

According to yet another aspect of the concepts and technologies disclosed herein, a computer storage medium is disclosed. The computer storage medium can store computer-executable instructions that, when executed by a processor, cause the processor to perform operations. The operations can include obtaining packet forwarding control protocol messages associated with a mobility network. The packet forwarding control protocol messages can relate to data communications, which can relate to a user equipment that is attached to the mobility network via a radio resource of the mobility network. The operations further can include correlating the packet forwarding control protocol messages to subscriber identities or device identities to obtain correlated packet forwarding control protocol messages; determining, based on the correlated packet forwarding control protocol messages, if the user equipment is associated with a malicious subscriber or includes a malicious device; in response to determining that the user equipment is associated with a malicious subscriber or includes a malicious device, selecting an interface via which the radio resource connects to a user plane of the mobility network; and triggering activation of an interface-located firewall on the interface to monitor data exchanged via the interface.

In some embodiments the mobility network can include a fifth generation cellular network, the interface can include an N3 interface, the radio resource can include a gNodeB, and the user plane traffic can occur between at least two of the gNodeB, a user plane function, or a session management function that controls the user plane function. In some embodiments the mobility network can include a fourth generation cellular network, the interface can include an S1-U interface, the radio resource can include an eNodeB, and the user plane traffic can occur between at least two of the eNodeB, a serving gateway user plane function/packet data network gateway user plane function, or a serving gateway control plane function/packet data network gateway control plane function that controls the serving gateway user plane function/packet data network gateway user plane function.

In some embodiments the device identity can include an international mobile equipment identity or a subscription permanent identifier, and the subscriber identity can include an international mobile subscriber identity. In some embodiments the interface-located firewall can be configured via firewall rules to determine, based on the communications of the user equipment via the interface, if the user equipment should be blocked from communicating with the mobility network. In some embodiments in response to determining that the user equipment should be blocked from communicating with the mobility network, the interface-located firewall can report a device identifier associated with the user equipment to a scrubbed IP domain service that controls the interface-located firewall. In some embodiments the scrubbed IP domain service can obtain the packet forwarding control protocol messages associated with the interface, and the scrubbed IP domain service can send firewall rules to the interface-located firewall to control the interface-located firewall.

Other systems, methods, and/or computer program products according to embodiments will be or become apparent to one with skill in the art upon review of the following drawings and detailed description. It is intended that all such additional systems, methods, and/or computer program products be included within this description and be within the scope of this disclosure.

### BRIEF DESCRIPTION OF THE DRAWINGS

FIG. 1 is a system diagram illustrating an illustrative operating environment for various embodiments of the concepts and technologies described herein.

FIG. 2 is a flow diagram showing aspects of a method for creating an interface-located firewall on a mobility network, according to an illustrative embodiment of the concepts and technologies described herein.

FIG. 3 is a flow diagram showing aspects of a method for identifying a relevant interface for placement of an interface-located firewall on a mobility network, according to an illustrative embodiment of the concepts and technologies described herein.

FIG. 4 is a flow diagram showing aspects of a method for managing communications using an interface-located firewall on a mobility network, according to an illustrative embodiment of the concepts and technologies described herein.

FIG. 5 schematically illustrates a network, according to an illustrative embodiment of the concepts and technologies described herein.

FIG. 6 is a block diagram illustrating an example computer system configured to provide mobility network support for scrubbed IP domains, according to some illustrative embodiments of the concepts and technologies described herein.

FIG. 7 is a block diagram illustrating an example mobile device, according to some illustrative embodiments of the concepts and technologies described herein.

FIG. 8 is a diagram illustrating a computing environment capable of implementing aspects of the concepts and technologies disclosed herein, according to some illustrative embodiments of the concepts and technologies described herein.

### DETAILED DESCRIPTION

The following detailed description is directed to mobility network support for scrubbed IP domains. By applying scrubbed IP domain technologies to mobility networks in a new manner, shared connections that share a similar network address translation (“NAT”) scheme (i.e., NAT'ed IP addresses) can be filtered on a device-level (e.g., by IMEI, SUPI, or the like) and/or subscriber-level (e.g., by IMSI or the like) to identify specific devices or subscribers associated with malicious content or traffic. Previous technologies may be unable to provide such filtering.

Furthermore, embodiments of the concepts and technologies disclosed herein can enable a new firewall on an interface between radio resources of a mobility network and the user plane of the mobility network. Thus, for example, an interface-located firewall can be provided to apply firewall rules to traffic occurring via the interfaces (e.g., the N3 interface of a 5G network and/or an S1-U interface of a 4G network), identify malicious activity, events, content, and/or traffic based on packet forwarding control protocol messages, take steps to block or allow devices or subscribers based on the identification, and to report device identifiers to the scrubbed IP domain service for further action.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

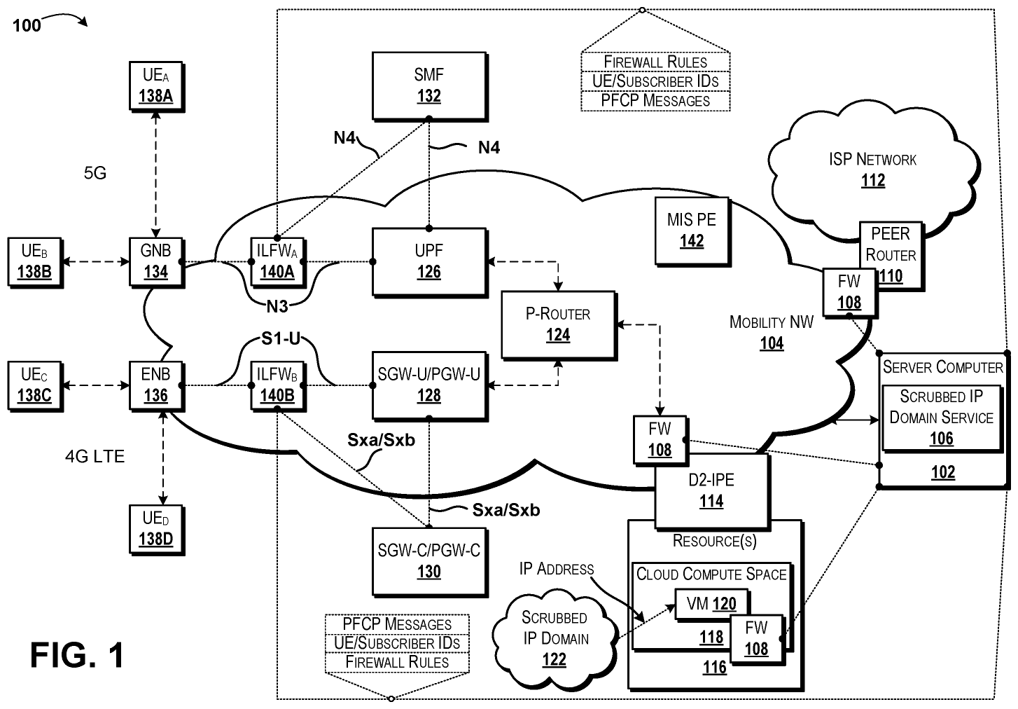

Referring now to FIG. 1, aspects of an operating environment 100 for various embodiments of the concepts and technologies disclosed herein for mobility network support for scrubbed IP domains will be described, according to an illustrative embodiment. The operating environment 100 shown in FIG. 1 includes a server computer 102. The server computer 102 can operate in communication with and/or as part of a communications network such as a mobility network and/or a component thereof such as a core backbone of a mobility network (hereinafter referred to as a “mobility network”) 104, though this is not necessarily the case.

According to various embodiments, the functionality of the server computer 102 may be provided by one or more server computers, desktop computers, mobile telephones, laptop computers, set-top boxes, other computing systems, and the like. It should be understood that the functionality of the server computer 102 may be provided by a single device, by two or more similar devices, and/or by two or more dissimilar devices. For purposes of describing the concepts and technologies disclosed herein, the server computer 102 is described herein as an application server or other type of server computer. It should be understood that this embodiment is illustrative, and should not be construed as being limiting in any way.

The server computer 102 can execute an operating system (not labeled in FIG. 1) and one or more application programs such as, for example, a scrubbed IP domain service 106. The operating system can include a computer program that can control the operation of the server computer 102. The scrubbed IP domain service 106 can include an executable program that can be configured to execute on top of the operating system to provide various functions as illustrated and described herein for providing mobility network support for scrubbed IP domains.

Although the scrubbed IP domain service 106 is illustrated in FIG. 1 as residing on and/or being executed by the server computer 102, it should be understood that the scrubbed IP domain service 106 may be embodied as or in stand-alone devices, resources, and/or components thereof operating as part of or in communication with the mobility network 104 and/or the server computer 102. As such, the illustrated embodiment should be understood as being illustrative of only some contemplated embodiments and should not be construed as being limiting in any way.

Before describing the functionality of the scrubbed IP domain service 106 in detail, the various components of the example operating environment 100 shown in FIG. 1 will be introduced to facilitate and simplify that description. The operating environment 100 can include one or more firewall devices or resources (“firewalls”) 108 (labeled “FW 108” in FIG. 1). Of course, it can be appreciated that the operating environment 100 includes three firewalls 108 in FIG. 1. The firewalls 108 can be controlled and/or otherwise can communicate with the scrubbed IP domain service 106, whereby the scrubbed IP domain service 106 can obtain messaging from the firewalls 108 (e.g., packet forwarding control protocol (“PFCP”) messages and/or other data that can represent communications occurring via the firewalls 108). Additionally, the scrubbed IP domain service 106 can be configured to provide data or commands to the firewalls 108 (e.g., to provide filter lists, IP addresses, network address translation (“NAT”) information, and/or other information) to instruct the firewalls 108 as to how to perform their firewall and/or other functions. It should be understood that this example embodiment is illustrative, and therefore should not be construed as being limiting in any way.

The operating environment 100 also can include one or more peering routers (labeled in FIG. 1 and referred to hereinafter as a “PEER router 110”). The PEER router 110 can support peering between two or more networks (e.g., the mobility network 104 and an Internet service provider (“ISP”) network 112) to enable and/or support network-to-network traffic (i.e., without engaging a third-party carrier for the data). As shown in FIG. 1, the PEER router 110 can be firewalled in various embodiments of the concepts and technologies disclosed herein to protect the connection between the mobility network 104 and the ISP network 112. It should be understood that this example embodiment is illustrative, and therefore should not be construed as being limiting in any way.

The operating environment 100 also can include one or more domain 2.0 infrastructure provider edge router (labeled in FIG. 1 and hereinafter referred to as a “D2-IPE 114”). Of course, it can be appreciated that the functionality of the D2-IPE 114 can be provided by other types of edge routers to enable communications between the mobility network 104 and one or more resources 116 (e.g., processing resources, storage resources, network resources, and/or the like) that support one or more cloud computing domains, cloud networks, or the like (labeled in FIG. 1 and hereinafter referred to as a “cloud compute space 118”). In the illustrated embodiment, the cloud compute space 118 can include a virtual machine 120 (labeled in FIG. 1 as “VM 120”), which can be assigned an IP address from a scrubbed IP space or domain (labeled in FIG. 1 and hereinafter referred to as a “scrubbed IP domain”) 122. As shown in FIG. 1, a firewall 108 can be located in the cloud compute space 118 to monitor and/or protect traffic exchanged by the cloud compute space 118 with other entities. It should be understood that this example embodiment is illustrative, and therefore should not be construed as being limiting in any way.

The operating environment 100 also can include a provider core router (labeled in FIG. 1 and hereinafter referred to as a “P-router”) 124. The P-router 124 can be configured to route traffic from one or more portions or components of the mobility network 104 to a user plane of the mobility network 104. Thus, the P-router 124 can support traffic being sent to and/or received from one or more entities on the user plane of the mobility network 104. Thus, it can be appreciated that the P-router 124 can exchange data between various components of the mobility network 104 (e.g., the D2-IPE 114 or other components) and a user plane function (“UPF”) 126 for 5G network technologies and/or a serving gateway user plane function (“SGW-U”) and packet data network (“PDN”) gateway user plane function (“PGW-U”) (labeled in FIG. 1 and hereinafter referred to as a “SGW-U/PGW-U”) 128 for 4G LTE technologies.

It can be appreciated these gateways can be controlled by other entities (e.g., the session management function (“SMF”) 132 in the case of the UPF 126 and the serving gateway control plane function (“SGW-C”) and PDN gateway control plane function (“PGW-C”) (labeled in FIG. 1 and hereinafter referred to as a “SGW-C/PGW-C”) 130). According to various embodiments of the concepts and technologies disclosed herein, the UPF 126 can be controlled by the SMF 132 via data exchange occurring via an N4 interface between these entities. Similarly, the SGW-U/PGW-U 128 can be controlled by the SGW-C/PGW-C 130 via data exchange occurring via an Sxa/Sxb interface between these entities. It should be understood that this example embodiment is illustrative, and therefore should not be construed as being limiting in any way.

The operating environment 100 also can include radio resources that can be configured to communicate with one or more devices communicating with the mobility network 104. The radio resources can include a gNodeB (“GNB”) 134 for 5G network technologies and an eNodeB (“ENB”) 136 for 4G LTE technologies. As is generally understood, an interface between the UPF 126 and the gNodeB 134 can include an N3 interface, which can be configured to convey user data received by the gNodeB 134 to the UPF 126. An interface between the SGW-U/PGW-U 128 and the eNodeB 136 can include an S1-U interface, which can be configured to convey user data received by the eNodeB 136 to the SGW-U/PGW-U 128. It should be understood that this example embodiment is illustrative, and therefore should not be construed as being limiting in any way.

As shown in FIG. 1, the operating environment 100 also can include one or more user equipment 138A-D (hereinafter collectively and/or generically referred to as a UE 138 and/or as “user equipment 138”). As is known, instances of user equipment 138 can include mobile telephones, tablet devices, laptops, smartwatches, and/or other network-enabled devices. Thus, it can be appreciated that the radio resources such as the gNodeB 134 and/or the eNodeB 136 can relay data to and/or from one or more user equipment 138 via the N3 interface and/or the S1-U interface to the UPF 126 and/or the SGW-U/PGW-U 128, respectively.

According to various embodiments of the concepts and technologies disclosed herein, the scrubbed IP domain service 106 can be configured to instantiate (or request instantiation of), enable, control, and/or communicate with one or more interface-located firewalls 140A-B (labeled in FIG. 1 as “ILFW 140A-B” and hereinafter collectively and/or generically referred to as “interface-located firewalls 140”). The interface-located firewalls 140 can be configured to provide firewall functionality for data exchanged via an N3 interface or an S1-U interface of the mobility network 104 (i.e., an interface between the serving gateway functionality of the mobility network 104 and the respective radio resources of the mobility network 104). It can be appreciated with reference to FIG. 1, that the interface-located firewalls 140 can therefore be configured to provide firewall functionality between the radio access network and the user plane of the mobility network 104. Thus, it can be appreciated that the interface-located firewalls 140 can provide firewall functionality across the N3 interface between the UPF 126 and the gNodeB 134 of a 5G portion of the mobility network 104 and/or for the S1-U interface between the SGW-U/PGW-U 128 and the eNodeB 136 of a 4G portion of the mobility network 104. It should be understood that this example embodiment is illustrative, and therefore should not be construed as being limiting in any way.

One or more of the interface-located firewalls 140 can be configured to provide network security for the mobility network 104, but can provide that security by monitoring inbound and outbound network traffic across the plane function interfaces (the N3 interface and the S1-U interface), which is not previously provided in mobility networks 104. Namely, because 4G and 5G networking technologies are built around low-latency computing (e.g., via connecting the radio access network of the mobility network 104 (e.g., the gNodeB 134 and the eNodeB 136) to the user plane functions via data tunneling from the radio access network to the UPF 126 and/or SGW-U/PGW-U 128), these interfaces are not firewalled in other networking approaches. Thus, the concepts and technologies disclosed herein provide new functionality by adding firewalling at these interfaces and thereby protecting the user plane from malicious and/or otherwise harmful traffic. Furthermore, the use of scrubbed IP technologies in association with the interface-located firewalls 140 can provide additional layers of protection for the mobility network 104 and/or other connected networks and/or resources such as the cloud compute space 118 and the like. It should be understood that this example embodiment is illustrative, and therefore should not be construed as being limiting in any way.

The operating environment 100 also can include one or more managed Internet service (“MIS”) provider edge router (“PE”) 142 (labeled in FIG. 1 and referred to hereinafter as an “MIS PE 142”). The MIS PE 142 can also be firewalled in various embodiments, although a firewall 108 is not illustrated in FIG. 1 in association with the MIS PE 142. Now that the various components of the operating environment 100 have been introduced, the functionality of the scrubbed IP domain service 106 and the interface-located firewalls 140 will be explained in more detail.

The scrubbed IP domain service 106 can be configured to implement network security policies through the core of the mobility network 104 such as, for example, the core backbone (“CBB”) of the mobility network 104, which can include Internet gateway routers (“IGRs”), provider edge routers (“PEs”), and/or area routers (“ARs”) and/or one or more cloud infrastructure provider edge routers (“IPEs”). The scrubbed IP domain service 106 can also be configured to apply the actual cloud security policies (e.g., Openstack security groups) and/or other security policies that can block known bot IP addresses and/or infected IP ranges, etc. Thus, the scrubbed IP domain service 106 can provide the scrubbed IP domain 122, which can include, among other things, address spaces for services and/or entities in the cloud compute space 118 (e.g., the virtual machine 120) for purposes of protecting Internet-facing services or applications. Embodiments of the concepts and technologies disclosed herein can extend the protection of the scrubbed IP domain 122 to the mobility network 104, as illustrated and described herein.

Embodiments of the concepts and technologies disclosed herein can extend the functionality of the scrubbed IP domain service 106 into the mobility network 104, not only by providing IP addressing from the scrubbed IP domain 122 (as shown in FIG. 1, an IP address for the virtual machine 120 and/or other entities may be provided from an address space in the scrubbed IP domain 122 in some embodiments), but also to provide device-identifier-level or subscriber-level protection for UEs 138 connecting to the mobility network 104 via the radio resources (e.g., the gNodeB 134 and/or the eNodeB 136). Thus, embodiments of the concepts and technologies disclosed herein can provide protection by applying security policies to specific devices, types of devices, subscribers, or the like, for example by tying security policies to specific device identifiers such as an International Mobile Equipment Identity (“IMEI”), an international mobile subscriber identity (“IMSI”), a subscription permanent identifier (“SUPI”), or other device or subscriber identifier.

According to some embodiments of the concepts and technologies disclosed herein, the ability of the scrubbed IP domain service 106 to communicate firewall rules that are subscriber-based or device-based to the interface-located firewall 140 can provide multiple benefits. First, because the interface-located firewall 140 is located on an interface between the user plane and the radio resources (e.g., between the UPF 126 and the gNodeB 134 and/or between the SGW-U/PGW-U 128 and the eNodeB 136), the interface-located firewall 140 can monitor traffic flowing via these interfaces. Also, the firewalls 108 can be used to monitor traffic flowing between the user plane to the Internet or cloud infrastructure (e.g., via an N6 interface, an SGi Interface, or the like). Thus, by combining the ability of the scrubbed IP domain service 106 to monitor, control, and/or interact with the firewalls 108 and the interface-located firewalls 140, the scrubbed IP domain service 106 can be configured to invoke specific security policies with regard to specific users or user equipment 138 via tying activity to specific IMEIs, SUPIs, IMSIs, or other identifiers.

By way of example, if a particular type of device (or device form a particular manufacturer) is determined by the scrubbed IP domain service 106 (e.g., via analysis of feedback from the firewalls 108, security alerts, and/or analysis of PFCP messages, or the like) to be part of a botnet, the scrubbed IP domain service 106 can issue firewall rules to one or more of the interface-located firewalls 140 to block activity associated with the specific UE IDs reported to the scrubbed IP domain service 106 (e.g., as part of the PFCP messages or otherwise). It can be appreciated that if a traditional firewalling approach was used with respect to the potentially malicious UE 138, other devices that share the same IP address (e.g., in some embodiments multiple UEs 138 may be network address translated out of the same interface (e.g., the N3 interface or the S1-U interface)) and therefore blocking a particular IP address may result in blocking the malicious traffic and legitimate traffic as well.

Thus, the interface-located firewalls 140 can be configured to enforce the firewall rules on the associated interface (e.g., the N3 interface or the S1-U interface), for example, by determining if traffic associated with a particular device (e.g., one of the UEs 138) associated with a particular subscriber ID (e.g., an IMSI or the like), device ID (e.g., an IMEI, SUPI, or the like) should be blocked from communicating with the mobility network 104. It can be appreciated that the interface-located firewalls 140 can effectively be aware of the PFCP messages to provide this functionality (e.g., enabled through the scrubbed IP domain service 106 and/or other functionality). It should be understood that this example embodiment is illustrative, and therefore should not be construed as being limiting in any way.

If the interface-located firewall 140 determines that traffic associated with a particular UE 138 should be blocked, the interface-located firewall 140 can block the traffic and report the blocking to the scrubbed IP domain service 106 for publication and/or further action (e.g., adding to block lists, etc.). If the interface-located firewall 140 determines that traffic associated with a particular UE 138 should not be blocked (or should be allowed), the interface-located firewall 140 can allow the traffic associated with the UE 138 to proceed through to the user plane (e.g., the UPF 126 and/or the SGW-U/PGW-U 128). It should be understood that this example embodiment is illustrative, and therefore should not be construed as being limiting in any way.

In practice, a mobility network 104 can include a 4G portion of the mobility network 104 and a 5G portion of the mobility network 104. The 4G portion of the mobility network 104 can include one or more radio resources such as one or more eNodeBs 136, one or more S1-U interfaces from the one or more eNodeBs 136 to one or more SGW-U/PGW-U 128, and an Sxa/Sxb interface from the SGW-U/PGW-U 128 to a control function such as one or more SGW-C/PGW-C 130. The 5G portion of the mobility network 104 can include one or more radio resources such as one or more gNodeBs 134, one or more N3 interfaces from the one or more gNodeBs 134 to one or more UPFs 126, and an N4 interface from the UPF 126 to a control function such as one or more SMF 132. One or more user equipment 138 can be connected to one or more of the radio resources.

PFCP messages can be exchanged between two or more of the radio resources (e.g., the gNodeB 134 and the eNodeB 136), user plane devices (e.g., the user plane function 126 and the SGW-U/PGW-U 128), control plane devices (e.g., the SMF 132 and the SGW-C/PGW-C 130), and/or one or more entities on the mobility network 104. A scrubbed IP domain service 106, which can provide scrubbed IP domains for other networks connected to the mobility network 104 (e.g., a cloud compute space 118 or the like) can be configured to analyze the PFCP messages and to identify, based on correlated PFCP messages, one or more subscribers or devices associated with the activity represented by the PFCP messages. The scrubbed IP domain service 106 can identify malicious or harmful traffic, content, or events; correlate that harmful traffic, content, or events with a particular user or subscriber; and perform operations to block the user or subscriber. A reporting mechanism can be included to provide device identifiers or subscriber identifiers to the scrubbed IP domain service for future action and/or trending purposes (e.g., to identify trends such as a particular type of device, device manufacturer, or the like that is associated with one or more threats). Thus, embodiments of the concepts and technologies disclosed herein enable device-level and/or subscriber level filtering of content and/or traffic in NAT'ed environments such as the mobility network 104. It should be understood that this example embodiment is illustrative, and therefore should not be construed as being limiting in any way.

FIG. 1 illustrates one server computer 102, one mobility network 104, three firewalls 108, one PEER Router 110, one ISP Network 112, one D2-IPE 114, one instance of resources 116, one cloud compute space 118, one virtual machine 120, one scrubbed IP domain 122, one P-Router 124, one UPF 126, one SGW-U/PGW-U 128, one SGW-C/PGW-C 130, one SMF 132, one gNodeB 134, one eNodeB 136, four UEs 138, two interface-located firewalls 140, and one MIS PE 142. It should be understood, however, that various implementations of the operating environment 100 can include zero, one, or more than one server computer 102; one or more than one mobility network 104; one, two, three, or more than three firewalls 108; zero, one, or more than one PEER Router 110; zero, one, or more than one ISP Network 112; zero, one, or more than one D2-IPE 114; one or more than one instance of resources 116; one or more than one cloud compute space 118; one or more than one virtual machine 120; one or more than one scrubbed IP domains 122; zero, one, or more than one P-Router 124; one or more than one UPF 126, SGW-U/PGW-U 128, GW-C/PGW-C 130, and/or SMF 132; one or more than one gNodeB 134 and/or eNodeB 136; one, two, three, four, or more than four UEs 138; one or more than one interface-located firewalls 140; and/or one or more MIS PE 142. As such, the illustrated embodiment should be understood as being illustrative, and should not be construed as being limiting in any way.

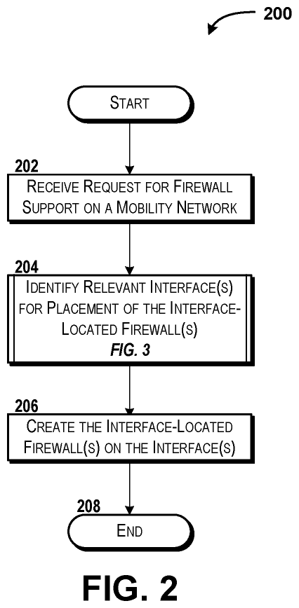

Turning now to FIG. 2, aspects of a method 200 for creating an interface-located firewall 140 on a mobility network 104 will be described in detail, according to an illustrative embodiment. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the concepts and technologies disclosed herein.

It also should be understood that the methods disclosed herein can be ended at any time and need not be performed in its entirety. Some or all operations of the methods, and/or substantially equivalent operations, can be performed by execution of computer-readable instructions included on a computer storage media, as defined herein. The term “computer-readable instructions,” and variants thereof, as used herein, is used expansively to include routines, applications, application modules, program modules, programs, components, data structures, algorithms, and the like. Computer-readable instructions can be implemented on various system configurations including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof. As used herein, the phrase “cause a processor to perform operations” and variants thereof is used to refer to causing a processor of a computing system or device, such as the server computer 102, to perform one or more operations and/or causing the processor to direct other components of the computing system or device to perform one or more of the operations.

For purposes of illustrating and describing the concepts of the present disclosure, the method 200 is described herein as being performed by the server computer 102 via execution of one or more software modules such as, for example, the scrubbed IP domain service 106. It should be understood that additional and/or alternative devices and/or network nodes can provide the functionality described herein via execution of one or more modules, applications, and/or other software including, but not limited to, the scrubbed IP domain service 106. Thus, the illustrated embodiments are illustrative, and should not be viewed as being limiting in any way.

The method 200 begins at operation 202. At operation 202, the server computer 102 can receive a request for firewall support on a mobility network such as the mobility network 104. This request can be generated in any number of manners. In some embodiments, for example, a firewall 108 may report malicious traffic or activity on the mobility network 104 and/or at other networks in communication with the mobility network 104 (e.g., the cloud compute space 118, the ISP network 112, or the like), and the scrubbed IP domain service 106 (which can be configured to control and exchange data with the firewalls 108) can be configured to order an interface-located firewall 140 to address the malicious traffic.

In some other embodiments, a network operator system or device can prompt creation of firewall resources based on intelligence reports, security breach information, security trends information, combinations thereof, or the like. Regardless of how the firewall functionality is requested in operation 202, the server computer 102 can determine (e.g., via execution of the scrubbed IP domain service 106) that firewall support is to be provided for a mobility network 104. In various embodiments of the concepts and technologies disclosed herein, operation 202 can further correspond to determining that firewall support is to be provided for an interface between the user plane and radio resources of the mobility network 104 (e.g., between the UPF 126 and the gNodeB 134 and/or between the SGW-U/PGW-U 128 and the eNodeB 136). It should be understood that this example embodiment is illustrative, and therefore should not be construed as being limiting in any way.

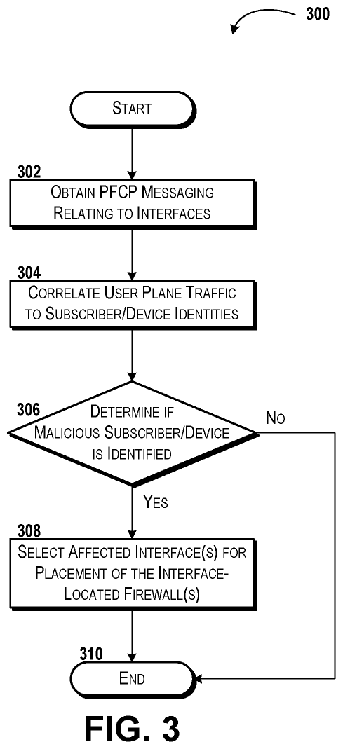

From operation 202, the method 200 can proceed to operation 204. At operation 204, the server computer 102 can identify a relevant interface (of the mobility network 104) for placement of the interface-located firewall 140. The functionality of the server computer 102 for identifying the relevant interface of the mobility network 104 for placement of the interface-located firewall 140 will be illustrated and described in more detail with reference to FIG. 3.

Briefly, however, the server computer 102 can be configured according to various embodiments of the concepts and technologies disclosed herein to determine the relevant interface(s) by executing the scrubbed IP domain service 106 to obtain PFCP messages from the N3 and/or S1-U interfaces, to correlate the user plane traffic to one or more subscriber identifiers (e.g., IMSIs, network IDs, or the like) and/or one or more device identifiers (e.g., IMEIs, SUPIs, or the like), to identify one or more devices or subscribers associated with harmful traffic and/or to determine if a malicious subscriber or device is identified (e.g., in association with the interface), and to select the affected interfaces for placement of an interface-located firewall 140 based on the subscriber or device identities, if identified. It should be understood that this example embodiment is illustrative, and therefore should not be construed as being limiting in any way.

From operation 204, the method 200 can proceed to operation 206. At operation 206, the server computer 102 can create the interface-based firewall 140 on the interface identified in operation 204. According to various embodiments, the server computer 102 can invoke other entities to create the interface-located firewall 140 in some embodiments. In some other embodiments, operation 206 can correspond to the server computer 102 activating an existing interface-located firewall 140 on the affected interface (i.e., the server computer 102 may not create or request creation of the interface-located firewall 140 and may instead merely activate the interface-located firewall 140 and/or issue rules to the interface-located firewall 140). It should be understood that these example embodiments are illustrative, and therefore should not be construed as being limiting in any way.

From operation 206, the method 200 can proceed to operation 208. The method 200 can end at operation 208.

Turning now to FIG. 3, aspects of a method 300 for identifying a relevant interface for placement of an interface-located firewall 140 on a mobility network 104 will be described in detail, according to an illustrative embodiment. For purposes of illustrating and describing the concepts of the present disclosure, the method 300 is described herein as being performed by the server computer 102 via execution of one or more software modules such as, for example, the scrubbed IP domain service 106. It should be understood that additional and/or alternative devices and/or network nodes can provide the functionality described herein via execution of one or more modules, applications, and/or other software including, but not limited to, the scrubbed IP domain service 106. Thus, the illustrated embodiments are illustrative, and should not be viewed as being limiting in any way.

The method 300 begins at operation 302. At operation 302, the server computer 102 can obtain PFCP messaging from the mobility network 104. In various embodiments, for example, the server computer 102 can obtain the PFCP messaging from between the SMF 132 and the UPF 126 in the 5G-enabled portion of the mobility network 104 and/or from between the SGW-C/PGW-C 130 and the SGW-U/PGW-U 128 in the 4G-LTE-enabled portion of the mobility network 104. It should be understood that this example embodiment is illustrative, and therefore should not be construed as being limiting in any way.

As is generally understood, PFCP is a protocol that can be used in mobility network such as the mobility network 104. In particular, PFCP is a third generation partnership project (“3GPP”) protocol that can be used for messaging between the control plane and the user plane functions (e.g., between the SMF 132 and the UPF 126 in 5G networks; between the SGW-U/PGW-U 128 and the SGW-C/PGW-C 130 in a 4G network) and/or otherwise on the Sx (e.g., Sxa/Sxb) interface and/or the N4 interface. Thus, the PFCP messages can correspond to instructions and/or reports between the control plane and the user plane of the mobility network 104 and therefore can represent attachment procedures (e.g., attaching UEs 138 to the mobility network 104, management of user data plane paths, delivery of some signaling (e.g., SMS messages), combinations thereof, or the like).

The PFCP messages also can represent packet forwarding rules and/or rules set by control plane elements, radio resource signaling and/or instructions and/or reports (e.g., from the gNodeB 134 and/or eNodeB 136), and/or other messages describing data communications and/or routing associated with the mobility network 104. Because PFCP messages and their contents are generally understood, they will not be further described here. It can be appreciated, however, that the PFCP messages can effectively describe signaling and/or communications between UEs 138 and the radio resources of the mobility network 104 (e.g., the gNodeB 134 and/or eNodeB 136); between the radio resources (e.g., the gNodeB 134 and/or eNodeB 136) and the user plane of the mobility network 104 (e.g., the UPF 126 and/or the SGW-U/PGW-U 128); between the user plane (e.g., the UPF 126 and/or the SGW-U/PGW-U 128) and the control plane (e.g., the SMF 132 and/or the SGW-C/PGW-C 130); data routing and/or data delivery operations; security rules; combinations thereof; or the like. Because the PFCP messages can describe other communications, it should be understood that these example embodiments are illustrative, and therefore should not be construed as being limiting in any way.

From operation 302, the method 300 can proceed to operation 304. At operation 304, the server computer 102 can analyze the PFCP messaging obtained in operation 302 and correlate user plane traffic to subscriber identities. Thus, in operation 304, the server computer 102 can correlate particular events (e.g., data received, device attachments, data routing, data deliveries, etc.) to particular devices (e.g., specific UEs 138) and/or particular subscribers. It can be appreciated that by correlating specific events (e.g., network traffic and/or network events) with specific devices and/or subscribers, that malicious and/or harmful traffic can be correlated to the specific devices and/or subscribers (as opposed to merely associating the activity with a particular IP address, which as mentioned above may be associated with multiple devices and/or subscribers). In any event, in operation 304 the server computer 102 can correlate these events and analyze the correlated data to potentially identify users or devices that are associated with harmful or malicious traffic. It should be understood that this example embodiment is illustrative, and therefore should not be construed as being limiting in any way.

From operation 304, the method 300 can proceed to operation 306. At operation 306, the server computer 102 can determine if a malicious subscriber or device is identified. It can be appreciated that the server computer 102 can determine, for example, if an interface between components of the mobility network 104 is supporting harmful traffic (e.g., malicious traffic, etc.) and/or if events associated with malicious or harmful traffic are detected; as well as if any events/traffic detected by the server computer 102 are associated with a particular user or device. From the above description, it can be appreciated that this information can be determined by the server computer 102 by analyzing the correlated information from the PFCP messages obtained in operation 302 in various embodiments. It should be understood that this example embodiment is illustrative, and therefore should not be construed as being limiting in any way.

If the server computer 102 determines, in operation 306, that a malicious subscriber or device is identified (e.g., by determining that an interface between components of the mobility network 104 is supporting harmful traffic or detecting abnormal or potentially malicious events), the method 300 can proceed to operation 308. At operation 308, the server computer 102 can select the affected interface for placement of the interface-located firewall 140. Thus, in operation 306, the server computer 102 can select an interface over which the harmful traffic or events are originating (e.g., the N3 interface of the S1-U interface between one or more of the UEs 138 and the gNodeB 134 and/or the eNodeB 136) or being communicated. It can be appreciated that in operation 306 the server computer 102 can identify more than one interface in some embodiments. It should be understood that this example embodiment is illustrative, and therefore should not be construed as being limiting in any way.

From operation 308, the method 300 can proceed to operation 310. The method 300 also can proceed to operation 310 from operation 306 if the server computer 102 determines, in operation 306, that a malicious subscriber or device is not identified (e.g., that no interface between components of the mobility network 104 is supporting or associated with harmful traffic and/or unusual and/or potentially malicious events). The method 300 can end at operation 310.

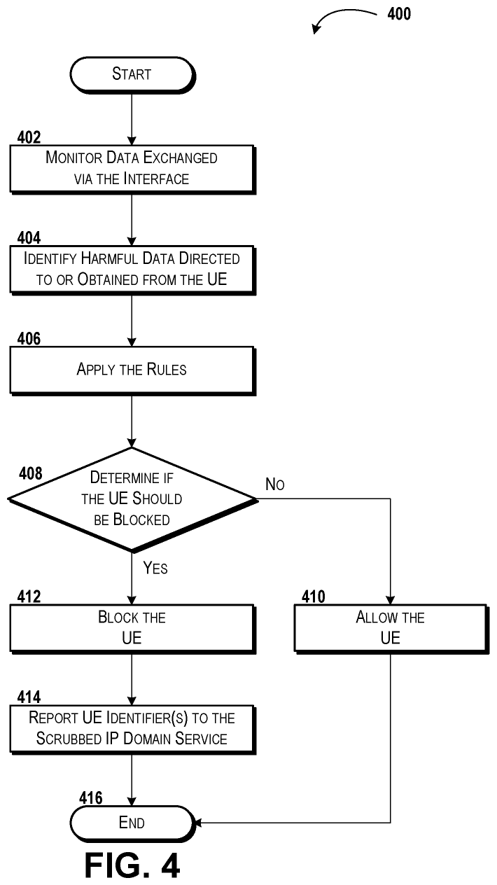

Turning now to FIG. 4, aspects of a method 400 for managing communications using an interface-located firewall 140 on a mobility network 104 will be described in detail, according to an illustrative embodiment. For purposes of illustrating and describing the concepts of the present disclosure, the method 400 is described herein as being performed by the interface-located firewall 140 via execution of one or more software modules such as, for example, a security application (not labeled in the FIGURES) that can be executed by the interface-located firewall 140 and configured by the scrubbed IP domain service 106 and/or rules issued by the scrubbed IP domain service 106. It should be understood that additional and/or alternative devices and/or network nodes can provide the functionality described herein via execution of one or more modules, applications, and/or other software including, but not limited to, the security application. Thus, the illustrated embodiments are illustrative, and should not be viewed as being limiting in any way.

Although not illustrated separately in FIG. 4, it should be understood that prior to operation 402, the interface-located firewall 140 can be configured by the scrubbed IP domain service 106. In some embodiments, the scrubbed IP domain service 106 can issue one or more firewall rules to the interface-located firewall 140 to configure the interface-located firewall 140. Because the interface-located firewall 140 can be configured in additional and/or alternative manners, it should be understood that this example embodiment is illustrative, and therefore should not be construed as being limiting in any way.

The method 400 begins at operation 402. At operation 402, the interface-located firewall 140 can monitor data exchanged (e.g., between a UE 138 and a radio resource such as the gNodeB 134 and/or the eNodeB 136) via the interface (e.g., the N3interface and/or the SU-1 interface) on which the interface-located firewall 140 is located. In various embodiments, the interface-located firewall 140 can have access to the PFCP messaging from the various components of the mobility network 104 operating on the user plane and control plane (e.g., the UPF 126 and SMF 132; the SGW-U/PGW-U 128 and SGW-C/PGW-C 130; and/or other components). The interface-located firewall 140 can monitor this data and detect data communications, events, and the like based on the monitoring and/or analysis of the PFCP messages.

From operation 402, the method 400 can proceed to operation 404. At operation 404, the interface-located firewall 140 can identify harmful data directed to and/or obtained from a particular device such as, for example, one or more of the UEs 138 and, particularly, a UE 138 served by the interface on which the interface-located firewall 140 is located. Although FIG. 4 illustrates the detecting of harmful data associated with a particular UE 138, it should be understood that operation 404 further can correspond to the interface-located firewall 140 detecting harmful data associated with a particular user or subscriber (and not only a particular device). It should be understood that this example embodiment is illustrative, and therefore should not be construed as being limiting in any way.

From operation 404, the method 400 can proceed to operation 406. At operation 406, the interface-located firewall 140 can apply rules at the interface-located firewall 140. Thus, for example, in operation 406 the interface-located firewall 140 can apply one or more firewall rules, which can be obtained from the scrubbed IP domain service 106 or other entities, and which can define rules to apply at the interface-located firewall 140 such as, for example, filtering rules, network address translation rules, security policies (e.g., blocking or allowing communications), and the like. In operation 406, these and/or other rules can be applied by the interface-located firewall 140 to the data exchange detected in operation 402. It should be understood that this example embodiment is illustrative, and therefore should not be construed as being limiting in any way.

From operation 406, the method 400 can proceed to operation 408. At operation 408, the interface-located firewall 140 can determine if the UE 138 associated with the data exchange monitored in operation 402 should be blocked (or in some embodiments, if the data exchange monitored in operation 402 should be allowed). In some embodiments, the interface-located firewall 140 could determine if the communication should be blocked based on determining that malicious and/or harmful events and/or data have been detected, by determining that a network security policy has been violated, and/or the like.

If the interface-located firewall 140 determines, in operation 408, that the UE 138 associated with the data exchange monitored in operation 402 should not be blocked (or in some embodiments, that the data exchange monitored in operation 402 should be allowed), the method 400 can proceed to operation 410. At operation 410, the interface-located firewall 140 can allow the UE 138 associated with the data exchange monitored in operation 402 to continue communicating via the interface. It should be understood that this example embodiment is illustrative, and therefore should not be construed as being limiting in any way.

If the interface-located firewall 140 determines, in operation 408, that the UE 138 associated with the data exchange monitored in operation 402 should be blocked (or in some embodiments, that the data exchange monitored in operation 402 should not be allowed), the method 400 can proceed to operation 412. At operation 412, the interface-located firewall 140 can block the UE 138 associated with the data exchange monitored in operation 402 from continuing communication via the interface. It should be understood that this example embodiment is illustrative, and therefore should not be construed as being limiting in any way.

From operation 412, the method 400 can proceed to operation 414. At operation 414, the interface-located firewall 140 can report UE identifiers (or subscriber identifiers) to the scrubbed IP domain service 106. This reporting mechanism of the interface-located firewall 140 can enable the scrubbed IP domain service 106 to protect against users of the mobility network 104 at Internet-facing components of the mobility network 104 (e.g., the cloud compute space 118), the ISP network 112, or the like to protect against subscribers, devices, customer premises subscribers, virtual machines 120, and/or other components. Because the reporting can be done for additional and/or alternative reasons, it should be understood that this example embodiment is illustrative, and therefore should not be construed as being limiting in any way.

From operation 414, the method 400 can proceed to operation 416. The method 400 can also proceed to operation 416 from operation 410. The method 400 can end at operation 416.

While the above description has generally described (and illustrated) the interface-located firewall 140 as being located on the N3 interface, it should be understood that the interface-located firewall 140 can also be located on and/or in communication with the N4 interface. Namely, the interface-located firewall 140 can obtain the PFCP messaging via the N4 interface as illustrated and described hereinabove. Similarly, while the above description has generally described (and illustrated) the interface-located firewall 140 as being located on the S1-U interface in the 4G portion of the mobility network 104, it should be understood that the interface-located firewall 140 can also be located on and/or in communication with the Sxa/Sxb interface. Namely, the interface-located firewall 140 can obtain the PFCP messaging via the Sxa/Sxb interface as illustrated and described hereinabove.

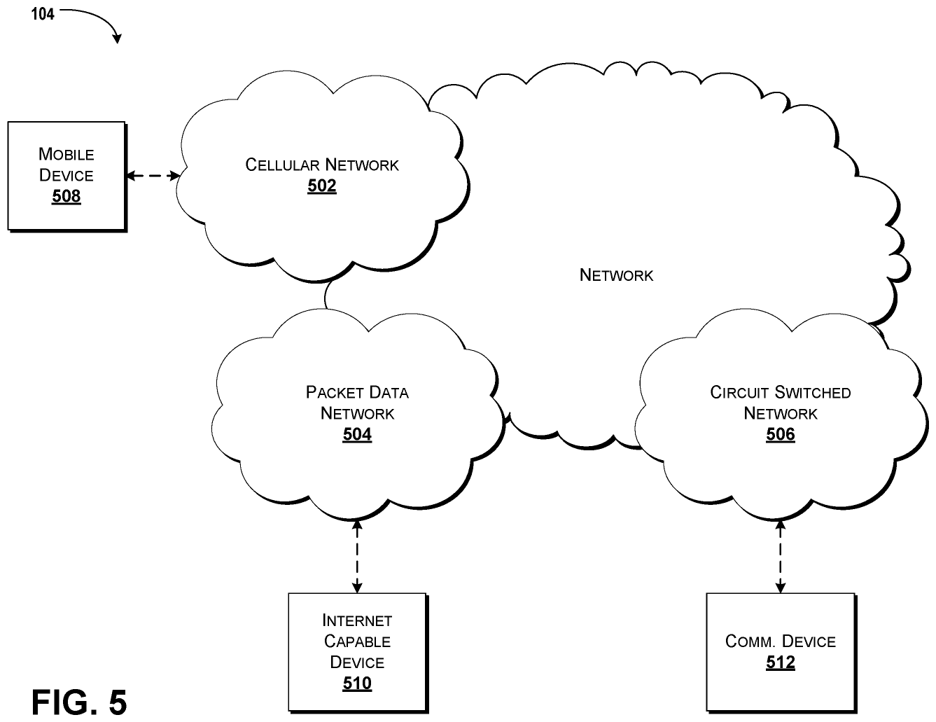

Turning now to FIG. 5, additional details of the mobility network 104 are illustrated, according to an illustrative embodiment. In the illustrated embodiment, the mobility network 104 can include a cellular network 502, a packet data network 504, for example, the Internet, and a circuit switched network 506, for example, a publicly switched telephone network (“PSTN”). The cellular network 502 can include various components such as, but not limited to, base transceiver stations (“BTSs”), NodeBs or eNodeBs 136, gNodeBs 134, or the like; base station controllers (“BSCs”) radio network controllers (“RNCs”), or the like; an evolved packet core (“EPC”); mobile switching centers (“MSCs” or “MSSs”); session management functions (“SMFs) 132; SGW-C/PGW-Cs 130, mobile management entities (“MMEs”); access and mobility management functions (“AMFs); authentication server functions (“AUSFs”), network slice selection functions (“NSSFs); network exposure functions (“NEFs”); policy control functions (“PCFs”); and various other functions in the user and control planes such as, for example, user plane functions (“UPFs) 126, SGW-U/PGW-Us 128, application functions (“AFs”), NF repository functions (“NRFs”), and the like; short message service centers (“SMSCs”); multimedia messaging service centers (“MMSCs”); home location registers (“HLRs”); home subscriber servers (“HSSs”); visitor location registers (“VLRs”); charging platforms; billing platforms; voicemail platforms; GPRS core network components; links to data networks (“DNs”) and/or other operator services, third party services, and/or the Internet; location service nodes, an IP Multimedia Subsystem (“IMS”); and the like. Of course, the cellular network 502 also can include various interfaces between various components, as is generally understood. The cellular network 502 also includes radios and nodes for receiving and transmitting voice, data, and combinations thereof to and from radio transceivers, networks, the packet data network 504, and the circuit switched network 506.

A mobile communications device 508, such as, for example, a cellular telephone, a user equipment, a mobile terminal, a PDA, a laptop computer, a handheld computer, and combinations thereof, can be operatively connected to the cellular network 502. The cellular network 502 can be configured as a 2G GSM network and can provide data communications via GPRS and/or EDGE. Additionally, or alternatively, the cellular network 502 can be configured as a 3G UMTS network and can provide data communications via the HSPA protocol family, for example, HSDPA, EUL (also referred to as HSUPA), and HSPA+. The cellular network 502 also is compatible with 4G mobile communications standards, 5G mobile communications standards, 6G mobile communication standards, other mobile communications standards, and evolved and future mobile communications standards.

The packet data network 504 includes various devices, for example, servers, computers, databases, and other devices in communication with one another, as is generally known. The packet data network 504 devices are accessible via one or more network links. The servers often store various files that are provided to a requesting device such as, for example, a computer, a terminal, a smartphone, or the like. Typically, the requesting device includes software (a “browser”) for executing a web page in a format readable by the browser or other software. Other files and/or data may be accessible via “links” in the retrieved files, as is generally known. In some embodiments, the packet data network 504 includes or is in communication with the Internet. The circuit switched network 506 includes various hardware and software for providing circuit switched communications. The circuit switched network 506 may include, or may be, what is often referred to as a plain old telephone system (POTS). The functionality of a circuit switched network 506 or other circuit-switched network are generally known and will not be described herein in detail.

The illustrated cellular network 502 is shown in communication with the packet data network 504 and a circuit switched network 506, though it should be appreciated that this is not necessarily the case. One or more Internet-capable devices 510, for example, a PC, a laptop, a portable device, or another suitable device, can communicate with one or more cellular networks 502, and devices connected thereto, through the packet data network 504. It also should be appreciated that the Internet-capable device 510 can communicate with the packet data network 504 through the circuit switched network 506, the cellular network 502, and/or via other networks (not illustrated).

As illustrated, a communications device 512, for example, a telephone, facsimile machine, modem, computer, or the like, can be in communication with the circuit switched network 506, and therethrough to the packet data network 504 and/or the cellular network 502. It should be appreciated that the communications device 512 can be an Internet-capable device, and can be substantially similar to the Internet-capable device 510. In the specification, the mobility network 104 is used to refer broadly to any combination of the networks 502, 504, 506. It should be appreciated that substantially all of the functionality described with reference to the mobility network 104 can be performed by the cellular network 502, the packet data network 504, and/or the circuit switched network 506, alone or in combination with other networks, network elements, and the like.

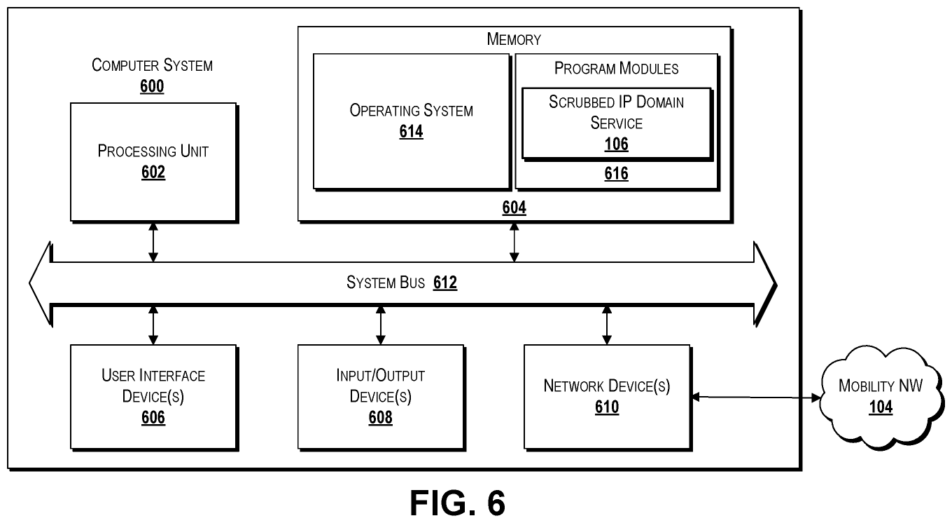

FIG. 6 is a block diagram illustrating a computer system 600 configured to provide the functionality described herein for providing mobility network support for scrubbed IP domains, in accordance with various embodiments of the concepts and technologies disclosed herein. As such, it can be appreciated that in some embodiments the server computer 102 may have an architecture similar or event identical to the computer system 600 illustrated and described in FIG. 6, though this is not necessarily the case in all embodiments. The computer system 600 includes a processing unit 602, a memory 604, one or more user interface devices 606, one or more input/output (“I/O”) devices 608, and one or more network devices 610, each of which is operatively connected to a system bus 612. The system bus 612 can enable bi-directional communication between the processing unit 602, the memory 604, the user interface devices 606, the I/O devices 608, and the network devices 610.

The processing unit 602 may be a standard central processor that performs arithmetic and logical operations, a more specific purpose programmable logic controller (“PLC”), a programmable gate array, or other type of processor known to those skilled in the art and suitable for controlling the operation of the server computer. As used herein, the word “processor” and/or the phrase “processing unit” when used with regard to any architecture or system can include multiple processors or processing units distributed across and/or operating in parallel in a single machine or in multiple machines. Furthermore, processors and/or processing units can be used to support virtual processing environments. Processors and processing units also can include state machines, application-specific integrated circuits (“ASICs”), combinations thereof, or the like. Because processors and/or processing units are generally known, the processors and processing units disclosed herein will not be described in further detail herein.

The memory 604 communicates with the processing unit 602 via the system bus 612. In some embodiments, the memory 604 is operatively connected to a memory controller (not shown) that enables communication with the processing unit 602 via the system bus 612. The memory 604 includes an operating system 614 and one or more program modules 616. The operating system 614 can include, but is not limited to, members of the WINDOWS, WINDOWS CE, and/or WINDOWS MOBILE families of operating systems from MICROSOFT CORPORATION, the LINUX family of operating systems, the SYMBIAN family of operating systems from SYMBIAN LIMITED, the BREW family of operating systems from QUALCOMM CORPORATION, the MAC OS, iOS, and/or SONOMA families of operating systems from APPLE CORPORATION, the FREEBSD family of operating systems, the SOLARIS family of operating systems from ORACLE CORPORATION, other operating systems, and the like.

The program modules 616 may include various software and/or program modules described herein. In some embodiments, for example, the program modules 616 can include the scrubbed IP domain service 106. This and/or other programs can be embodied in computer-readable media containing instructions that, when executed by the processing unit 602, perform one or more of the methods 200, 300, and 400 described in detail above with respect to FIGS. 2-4 and/or other functionality as illustrated and described herein. It can be appreciated that, at least by virtue of the instructions embodying the methods 200, 300, 400, and/or other functionality illustrated and described herein being stored in the memory 604 and/or accessed and/or executed by the processing unit 602, the computer system 600 is a special-purpose computing system that can facilitate providing the functionality illustrated and described herein. According to embodiments, the program modules 616 may be embodied in hardware, software, firmware, or any combination thereof. Although not shown in FIG. 6, it should be understood that the memory 604 also can be configured to store the firewall rules, the UE/Subscriber IDs, IP addresses, the PFCP messages, and/or other data, if desired.

By way of example, and not limitation, computer-readable media may include any available computer storage media or communication media that can be accessed by the computer system 600. Communication media includes computer-readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Computer storage media includes only non-transitory embodiments of computer readable media as illustrated and described herein. Thus, computer storage media can include volatile and non-volatile, removable and non-removable media implemented in any method or technology for storage of information such as computer-readable instructions, data structures, program modules, or other data. Computer storage media includes, but is not limited to, RAM, ROM, Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer system 600. In the claims, the phrase “computer storage medium” and variations thereof does not include waves or signals per se and/or communication media.

The user interface devices 606 may include one or more devices with which a user accesses the computer system 600. The user interface devices 606 may include, but are not limited to, computers, servers, personal digital assistants, cellular phones, or any suitable computing devices. The I/O devices 608 enable a user to interface with the program modules 616. In one embodiment, the I/O devices 608 are operatively connected to an I/O controller (not shown) that enables communication with the processing unit 602 via the system bus 612. The I/O devices 608 may include one or more input devices, such as, but not limited to, a keyboard, a mouse, or an electronic stylus. Further, the I/O devices 608 may include one or more output devices, such as, but not limited to, a display screen or a printer.

The network devices 610 enable the computer system 600 to communicate with other networks or remote systems via a network, such as the mobility network 104. Examples of the network devices 610 include, but are not limited to, a modem, a radio frequency (“RF”) or infrared (“IR”) transceiver, a telephonic interface, a bridge, a router, or a network card. The mobility network 104 may include a wireless network such as, but not limited to, a Wireless Local Area Network (“WLAN”) such as a WI-FI network, a Wireless Wide Area Network (“WWAN”), a Wireless Personal Area Network (“WPAN”) such as BLUETOOTH, a Wireless Metropolitan Area Network (“WMAN”) such a WiMAX network, or a cellular network. Alternatively, the mobility network 104 may be a wired network such as, but not limited to, a Wide Area Network (“WAN”) such as the Internet, a Local Area Network (“LAN”) such as the Ethernet, a wired Personal Area Network (“PAN”), or a wired Metropolitan Area Network (“MAN”).

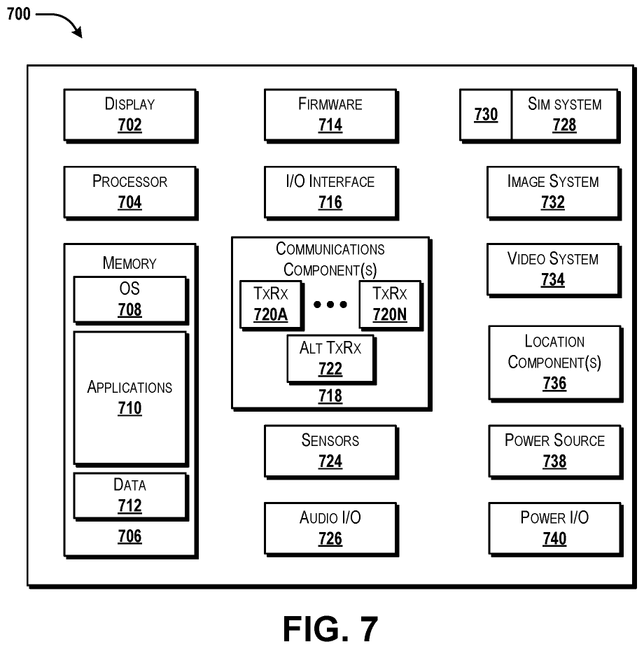

Turning now to FIG. 7, an illustrative mobile device 700 and components thereof will be described. In some embodiments, the UEs 138 described above with reference to FIGS. 1-4 can be configured as and/or can have an architecture similar or identical to the mobile device 700 described herein in FIG. 7, though this is not necessary the case in all embodiments. While connections are not shown between the various components illustrated in FIG. 7, it should be understood that some, none, or all of the components illustrated in FIG. 7 can be configured to interact with one another to carry out various device functions. In some embodiments, the components are arranged so as to communicate via one or more busses (not shown). Thus, it should be understood that FIG. 7 and the following description are intended to provide a general understanding of a suitable environment in which various aspects of embodiments can be implemented, and should not be construed as being limiting in any way.

As illustrated in FIG. 7, the mobile device 700 can include a display 702 for displaying data. According to various embodiments, the display 702 can be configured to display various graphical user interface (“GUI”) elements such as, for example, text, images, video, virtual keypads and/or keyboards, messaging data, notification messages, metadata, internet content, device status, time, date, calendar data, device preferences, map and location data, combinations thereof, and/or the like. The mobile device 700 also can include a processor 704 and a memory or other data storage device (“memory”) 706. The processor 704 can be configured to process data and/or can execute computer-executable instructions stored in the memory 706. The computer-executable instructions executed by the processor 704 can include, for example, an operating system 708, one or more applications 710, other computer-executable instructions stored in a memory 706, or the like. In some embodiments, the applications 710 also can include a UI application (not illustrated in FIG. 7).

The UI application can interface with the operating system 708 to facilitate user interaction with functionality and/or data stored at the mobile device 700 and/or stored elsewhere. In some embodiments, the operating system 708 can include a member of the SYMBIAN OS family of operating systems from SYMBIAN LIMITED, a member of the WINDOWS MOBILE OS and/or WINDOWS PHONE OS families of operating systems from MICROSOFT CORPORATION, a member of the PALM WEBOS family of operating systems from HEWLETT PACKARD CORPORATION, a member of the BLACKBERRY OS family of operating systems from RESEARCH IN MOTION LIMITED, a member of the IOS family of operating systems from APPLE INC., a member of the ANDROID OS family of operating systems from GOOGLE INC., and/or other operating systems. These operating systems are merely illustrative of some contemplated operating systems that may be used in accordance with various embodiments of the concepts and technologies described herein and therefore should not be construed as being limiting in any way.

The UI application can be executed by the processor 704 to aid a user in entering content, configuring settings, manipulating address book content and/or settings, multimode interaction, interacting with other applications 710, and otherwise facilitating user interaction with the operating system 708, the applications 710, and/or other types or instances of data 712 that can be stored at the mobile device 700. According to various embodiments, the data 712 can include, for example, presence applications, visual voice mail applications, messaging applications, text-to-speech and speech-to-text applications, add-ons, plug-ins, email applications, music applications, video applications, camera applications, location-based service applications, power conservation applications, game applications, productivity applications, entertainment applications, enterprise applications, combinations thereof, and the like. The applications 710, the data 712, and/or portions thereof can be stored in the memory 706 and/or in a firmware 714, and can be executed by the processor 704.

It can be appreciated that, at least by virtue of storage of the instructions corresponding to the applications 710 and/or other instructions embodying other functionality illustrated and described herein in the memory 706, and/or by virtue of the instructions corresponding to the applications 710 and/or other instructions embodying other functionality illustrated and described herein being accessed and/or executed by the processor 704, the mobile device 700 is a special-purpose mobile device that can facilitate providing the functionality illustrated and described herein. The firmware 714 also can store code for execution during device power up and power down operations. It can be appreciated that the firmware 714 can be stored in a volatile or non-volatile data storage device including, but not limited to, the memory 706 and/or a portion thereof.

The mobile device 700 also can include an input/output (“I/O”) interface 716. The I/O interface 716 can be configured to support the input/output of data such as location information, user information, organization information, presence status information, user IDs, passwords, and application initiation (start-up) requests. In some embodiments, the I/O interface 716 can include a hardwire connection such as a universal serial bus (“USB”) port, a mini-USB port, a micro-USB port, an audio jack, a PS2 port, an IEEE 1394(“FIREWIRE”) port, a serial port, a parallel port, an Ethernet (RJ45 or RJ48) port, a telephone (RJ11 or the like) port, a proprietary port, combinations thereof, or the like. In some embodiments, the mobile device 700 can be configured to synchronize with another device to transfer content to and/or from the mobile device 700. In some embodiments, the mobile device 700 can be configured to receive updates to one or more of the applications 710 via the I/O interface 716, though this is not necessarily the case. In some embodiments, the I/O interface 716 accepts I/O devices such as keyboards, keypads, mice, interface tethers, printers, plotters, external storage, touch/multi-touch screens, touch pads, trackballs, joysticks, microphones, remote control devices, displays, projectors, medical equipment (e.g., stethoscopes, heart monitors, and other health metric monitors), modems, routers, external power sources, docking stations, combinations thereof, and the like. It should be appreciated that the I/O interface 716 may be used for communications between the mobile device 700 and a network device or local device.

The mobile device 700 also can include a communications component 718. The communications component 718 can be configured to interface with the processor 704 to facilitate wired and/or wireless communications with one or more networks such as the mobility network 104 described herein. In some embodiments, other networks include networks that utilize non-cellular wireless technologies such as WI-FI or WIMAX. In some embodiments, the communications component 718 includes a multimode communications subsystem for facilitating communications via the cellular network and one or more other networks.

The communications component 718, in some embodiments, includes one or more transceivers. The one or more transceivers, if included, can be configured to communicate over the same and/or different wireless technology standards with respect to one another. For example, in some embodiments one or more of the transceivers of the communications component 718 may be configured to communicate using GSM, CDMAONE, CDMA2000, LTE, and various other 2G, 2.5G, 3G, 4G, 5G, 6G, and greater generation technology standards. Moreover, the communications component 718 may facilitate communications over various channel access methods (which may or may not be used by the aforementioned standards) including, but not limited to, TDMA, FDMA, W-CDMA, OFDM, SDMA, and the like.

In addition, the communications component 718 may facilitate data communications using GPRS, EDGE, the HSPA protocol family including HSDPA, EUL or otherwise termed HSUPA, HSPA+, and various other current and future wireless data access standards. In the illustrated embodiment, the communications component 718 can include a first transceiver (“TxRx”) 720A that can operate in a first communications mode (e.g., GSM). The communications component 718 also can include an Nth transceiver (“TxRx”) 720N that can operate in a second communications mode relative to the first transceiver 720A (e.g., UMTS). While two transceivers 720A-N (hereinafter collectively and/or generically referred to as “transceivers 720”) are shown in FIG. 7, it should be appreciated that less than two, two, and/or more than two transceivers 720 can be included in the communications component 718.

The communications component 718 also can include an alternative transceiver (“Alt TxRx”) 722 for supporting other types and/or standards of communications. According to various contemplated embodiments, the alternative transceiver 722 can communicate using various communications technologies such as, for example, WI-FI, WIMAX, BLUETOOTH, infrared, infrared data association (“IRDA”), near field communications (“NFC”), other RF technologies, combinations thereof, and the like. In some embodiments, the communications component 718 also can facilitate reception from terrestrial radio networks, digital satellite radio networks, internet-based radio service networks, combinations thereof, and the like. The communications component 718 can process data from a network such as the Internet, an intranet, a broadband network, a WI-FI hotspot, an Internet service provider (“ISP”), a digital subscriber line (“DSL”) provider, a broadband provider, combinations thereof, or the like.

The mobile device 700 also can include one or more sensors 724. The sensors 724 can include temperature sensors, light sensors, air quality sensors, movement sensors, orientation sensors, noise sensors, proximity sensors, or the like. As such, it should be understood that the sensors 724 can include, but are not limited to, accelerometers, magnetometers, gyroscopes, infrared sensors, noise sensors, microphones, combinations thereof, or the like. Additionally, audio capabilities for the mobile device 700 may be provided by an audio I/O component 726. The audio I/O component 726 of the mobile device 700 can include one or more speakers for the output of audio signals, one or more microphones for the collection and/or input of audio signals, and/or other audio input and/or output devices.

The illustrated mobile device 700 also can include a subscriber identity module (“SIM”) system 728. The SIM system 728 can include a universal SIM (“USIM”), a universal integrated circuit card (“UICC”) and/or other identity devices. The SIM system 728 can include and/or can be connected to or inserted into an interface such as a slot interface 730. In some embodiments, the slot interface 730 can be configured to accept insertion of other identity cards or modules for accessing various types of networks. Additionally, or alternatively, the slot interface 730 can be configured to accept multiple subscriber identity cards. Because other devices and/or modules for identifying users and/or the mobile device 700 are contemplated, it should be understood that these embodiments are illustrative, and should not be construed as being limiting in any way.

The mobile device 700 also can include an image capture and processing system 732 (“image system”). The image system 732 can be configured to capture or otherwise obtain photos, videos, and/or other visual information. As such, the image system 732 can include cameras, lenses, charge-coupled devices (“CCDs”), combinations thereof, or the like. The mobile device 700 may also include a video system 734. The video system 734 can be configured to capture, process, record, modify, and/or store video content. Photos and videos obtained using the image system 732 and the video system 734, respectively, may be added as message content to an MMS message, email message, and sent to another mobile device. The video and/or photo content also can be shared with other devices via various types of data transfers via wired and/or wireless communication devices as described herein.

The mobile device 700 also can include one or more location components 736. The location components 736 can be configured to send and/or receive signals to determine a geographic location of the mobile device 700. According to various embodiments, the location components 736 can send and/or receive signals from global positioning system (“GPS”) devices, assisted-GPS (“A-GPS”) devices, WI-FI/WIMAX and/or cellular network triangulation data, combinations thereof, and the like. The location component 736 also can be configured to communicate with the communications component 718 to retrieve triangulation data for determining a location of the mobile device 700. In some embodiments, the location component 736 can interface with cellular network nodes, telephone lines, satellites, location transmitters and/or beacons, wireless network transmitters and receivers, combinations thereof, and the like. In some embodiments, the location component 736 can include and/or can communicate with one or more of the sensors 724 such as a compass, an accelerometer, and/or a gyroscope to determine the orientation of the mobile device 700. Using the location component 736, the mobile device 700 can generate and/or receive data to identify its geographic location, or to transmit data used by other devices to determine the location of the mobile device 700. The location component 736 may include multiple components for determining the location and/or orientation of the mobile device 700.

The illustrated mobile device 700 also can include a power source 738. The power source 738 can include one or more batteries, power supplies, power cells, and/or other power subsystems including alternating current (“AC”) and/or direct current (“DC”) power devices. The power source 738 also can interface with an external power system or charging equipment via a power I/O component 740. Because the mobile device 700 can include additional and/or alternative components, the above embodiment should be understood as being illustrative of one possible operating environment for various embodiments of the concepts and technologies described herein. The described embodiment of the mobile device 700 is illustrative, and should not be construed as being limiting in any way.

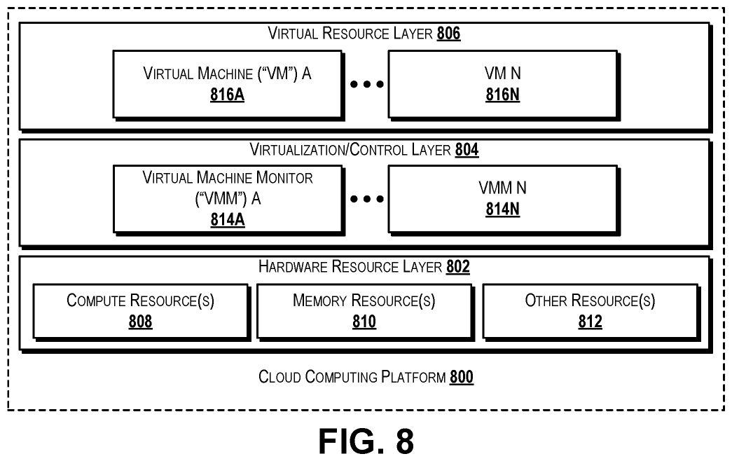

FIG. 8 illustrates an illustrative architecture for a cloud computing platform 800 that can be capable of executing the software components described herein for providing mobility network support for scrubbed IP domains and/or for interacting with the scrubbed IP domain service 106. Thus, it can be appreciated that in some embodiments of the concepts and technologies disclosed herein, the cloud computing platform 800 illustrated in FIG. 8 can be used to provide the functionality described herein with respect to the server computer 102, the resources 116, and/or one or more of the illustrated components of the mobility network 104.

The cloud computing platform 800 thus may be utilized to execute any aspects of the software components presented herein. Thus, according to various embodiments of the concepts and technologies disclosed herein, the scrubbed IP domain service 106 can be implemented, at least in part, on or by elements included in the cloud computing platform 800 illustrated and described herein. Those skilled in the art will appreciate that the illustrated cloud computing platform 800 is a simplification of but only one possible implementation of an illustrative cloud computing platform, and as such, the illustrated cloud computing platform 800 should not be construed as being limiting in any way.

In the illustrated embodiment, the cloud computing platform 800 can include a hardware resource layer 802, a virtualization/control layer 804, and a virtual resource layer 806. These layers and/or other layers can be configured to cooperate with each other and/or other elements of a cloud computing platform 800 to perform operations as will be described in detail herein. While connections are shown between some of the components illustrated in FIG. 8, it should be understood that some, none, or all of the components illustrated in FIG. 8 can be configured to interact with one another to carry out various functions described herein. In some embodiments, the components are arranged so as to communicate via one or more networks such as, for example, the mobility network 104 illustrated and described hereinabove (not shown in FIG. 8). Thus, it should be understood that FIG. 8 and the following description are intended to provide a general understanding of a suitable environment in which various aspects of embodiments can be implemented, and should not be construed as being limiting in any way.

The hardware resource layer 802 can provide hardware resources. In the illustrated embodiment, the hardware resources can include one or more compute resources 808, one or more memory resources 810, and one or more other resources 812. The compute resource(s) 808 can include one or more hardware components that can perform computations to process data, and/or to execute computer-executable instructions of one or more application programs, operating systems, services, and/or other software including, but not limited to, the firewalls 108 and/or the interface-located firewalls 140 illustrated and described herein.

According to various embodiments, the compute resources 808 can include one or more central processing units (“CPUs”). The CPUs can be configured with one or more processing cores. In some embodiments, the compute resources 808 can include one or more graphics processing units (“GPUs”). The GPUs can be configured to accelerate operations performed by one or more CPUs, and/or to perform computations to process data, and/or to execute computer-executable instructions of one or more application programs, operating systems, and/or other software that may or may not include instructions that are specifically graphics computations and/or related to graphics computations. In some embodiments, the compute resources 808 can include one or more discrete GPUs. In some other embodiments, the compute resources 808 can include one or more CPU and/or GPU components that can be configured in accordance with a co-processing CPU/GPU computing model. Thus, it can be appreciated that in some embodiments of the compute resources 808, a sequential part of an application can execute on a CPU and a computationally-intensive part of the application can be accelerated by the GPU. It should be understood that this example is illustrative, and therefore should not be construed as being limiting in any way.

In some embodiments, the compute resources 808 also can include one or more system on a chip (“SoC”) components. It should be understood that an SoC component can operate in association with one or more other components as illustrated and described herein, for example, one or more of the memory resources 810 and/or one or more of the other resources 812. In some embodiments in which an SoC component is included, the compute resources 808 can be or can include one or more embodiments of the SNAPDRAGON brand family of SoCs, available from QUALCOMM of San Diego, California; one or more embodiment of the TEGRA brand family of SoCs, available from NVIDIA of Santa Clara, California; one or more embodiment of the HUMMINGBIRD brand family of SoCs, available from SAMSUNG of Seoul, South Korea; one or more embodiment of the Open Multimedia Application Platform (“OMAP”) family of SoCs, available from TEXAS INSTRUMENTS of Dallas, Texas; one or more customized versions of any of the above SoCs; and/or one or more other brand and/or one or more proprietary SoCs.

The compute resources 808 can be or can include one or more hardware components arranged in accordance with an ARM architecture, available for license from ARM HOLDINGS of Cambridge, United Kingdom. Alternatively, the compute resources 808 can be or can include one or more hardware components arranged in accordance with an x86 architecture, such as an architecture available from INTEL CORPORATION of Mountain View, California, and others. Those skilled in the art will appreciate the implementation of the compute resources 808 can utilize various computation architectures and/or processing architectures. As such, the various example embodiments of the compute resources 808 as mentioned hereinabove should not be construed as being limiting in any way. Rather, implementations of embodiments of the concepts and technologies disclosed herein can be implemented using compute resources 808 having any of the particular computation architecture and/or combination of computation architectures mentioned herein as well as other architectures.

Although not separately illustrated in FIG. 8, it should be understood that the compute resources 808 illustrated and described herein can host and/or execute various services, applications, portals, and/or other functionality illustrated and described herein. Thus, the compute resources 808 can host and/or can execute the scrubbed IP domain service 106 or other applications or services illustrated and described herein.

The memory resource(s) 810 can include one or more hardware components that can perform or provide storage operations, including temporary and/or permanent storage operations. In some embodiments, the memory resource(s) 810 can include volatile and/or non-volatile memory implemented in any method or technology for storage of information such as computer-readable instructions, data structures, program modules, or other data disclosed herein. Computer storage media is defined hereinabove and therefore should be understood as including, in various embodiments, random access memory (“RAM”), read-only memory (“ROM”), Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium that can be used to store data and that can be accessed by the compute resources 808, subject to the definition of “computer storage media” provided above (e.g., as excluding waves and signals per se and/or communication media as defined in this application).

Although not illustrated in FIG. 8, it should be understood that the memory resources 810 can host or store the various data illustrated and described herein including, but not limited to, firewall rules, IP addresses, the UE/Subscriber IDs, the PFCP messages, and/or other data, if desired. It should be understood that this example is illustrative, and therefore should not be construed as being limiting in any way.

The other resource(s) 812 can include any other hardware resources that can be utilized by the compute resources(s) 808 and/or the memory resource(s) 810 to perform operations. The other resource(s) 812 can include one or more input and/or output processors (e.g., a network interface controller and/or a wireless radio), one or more modems, one or more codec chipsets, one or more pipeline processors, one or more fast Fourier transform (“FFT”) processors, one or more digital signal processors (“DSPs”), one or more speech synthesizers, combinations thereof, or the like.

The hardware resources operating within the hardware resource layer 802 can be virtualized by one or more virtual machine monitors (“VMMs”) 814A-814N (also known as “hypervisors;” hereinafter “VMMs 814”). The VMMs 814 can operate within the virtualization/control layer 804 to manage one or more virtual resources that can reside in the virtual resource layer 806. The VMMs 814 can be or can include software, firmware, and/or hardware that alone or in combination with other software, firmware, and/or hardware, can manage one or more virtual resources operating within the virtual resource layer 806.

The virtual resources operating within the virtual resource layer 806 can include abstractions of at least a portion of the compute resources 808, the memory resources 810, the other resources 812, or any combination thereof. These abstractions are referred to herein as virtual machines (“VMs”). In the illustrated embodiment, the virtual resource layer 806 includes VMs 816A-816N (hereinafter “VMs 816”).

Based on the foregoing, it should be appreciated that systems and methods for providing mobility network support for scrubbed IP domains have been disclosed herein. Although the subject matter presented herein has been described in language specific to computer structural features, methodological and transformative acts, specific computing machinery, and computer-readable media, it is to be understood that the concepts and technologies disclosed herein are not necessarily limited to the specific features, acts, or media described herein. Rather, the specific features, acts and mediums are disclosed as example forms of implementing the concepts and technologies disclosed herein.

The subject matter described above is provided by way of illustration only and should not be construed as limiting. Various modifications and changes may be made to the subject matter described herein without following the example embodiments and applications illustrated and described, and without departing from the true spirit and scope of the embodiments of the concepts and technologies disclosed herein.

1. A system comprising:
a processor; and
a memory that stores computer-executable instructions that, when executed by the processor, cause the processor to perform operations comprising
obtaining packet forwarding control protocol messages associated with a mobility network, the packet forwarding control protocol messages relating to data communications relating to a user equipment that is attached to the mobility network via a radio resource of the mobility network, the data communications comprising user plane traffic;
correlating the packet forwarding control protocol messages to subscriber identities or device identities to obtain correlated packet forwarding control protocol messages;
determining, based on the correlated packet forwarding control protocol messages associated, if the user equipment is associated with a malicious subscriber or comprises a malicious device;
in response to determining that the user equipment is associated with the malicious subscriber or comprises the malicious device, selecting an interface via which the radio resource connects to a user plane of the mobility network; and
triggering activation of an interface-located firewall on the interface to monitor data exchanged via the interface.

2. The system of claim 1, wherein the mobility network comprises a fifth generation cellular network, wherein the interface comprises an N3 interface, wherein the radio resource comprises a gNodeB, and wherein the user plane traffic occurs between at least two of the gNodeB, a user plane function, or a session management function that controls the user plane function.

3. The system of claim 1, wherein the mobility network comprises a fourth generation cellular network, wherein the interface comprises an S1-U interface, wherein the radio resource comprises an eNodeB, and wherein the user plane traffic occurs between at least two of the eNodeB, a serving gateway user plane function/packet data network gateway user plane function, or a serving gateway control plane function/packet data network gateway control plane function that controls the serving gateway user plane function/packet data network gateway user plane function.

4. The system of claim 1, wherein the device identities comprise an international mobile equipment identity or a subscription permanent identifier, and wherein the subscriber identities comprise an international mobile subscriber identity.

5. The system of claim 1, wherein the interface-located firewall is configured via firewall rules to determine, based on the data communications of the user equipment via the interface, if the user equipment should be blocked from communicating with the mobility network.

6. The system of claim 5, wherein in response to determining that the user equipment should be blocked from communicating with the mobility network, the interface-located firewall reports a device identifier associated with the user equipment to a scrubbed IP domain service that controls the interface-located firewall.

7. The system of claim 6, wherein the scrubbed IP domain service obtains the packet forwarding control protocol messages associated with the interface, and wherein the scrubbed IP domain service sends firewall rules to the interface-located firewall to control the interface-located firewall.

8. A method comprising:
obtaining, by a computer comprising a processor, packet forwarding control protocol messages associated with a mobility network, the packet forwarding control protocol messages relating to data communications relating to a user equipment that is attached to the mobility network via a radio resource of the mobility network, the data communications comprising user plane traffic;
correlating, by the processor, the packet forwarding control protocol messages to subscriber identities or device identities to obtain correlated packet forwarding control protocol messages;
determining, by the processor and based on the correlated packet forwarding control protocol messages, if the user equipment is associated with a malicious subscriber or comprises a malicious device;
in response to determining that the user equipment is associated with the malicious subscriber or comprises the malicious device, selecting, by the processor, an interface via which the radio resource connects to a user plane of the mobility network; and
triggering activation of an interface-located firewall on the interface to monitor data exchanged via the interface.

9. The method of claim 8, wherein the mobility network comprises a fifth generation cellular network, wherein the interface comprises an N3 interface, wherein the radio resource comprises a gNodeB, and wherein the user plane traffic occurs between at least two of the gNodeB, a user plane function, or a session management function that controls the user plane function.

10. The method of claim 8, wherein the mobility network comprises a fourth generation cellular network, wherein the interface comprises an S1-U interface, wherein the radio resource comprises an eNodeB, and wherein the user plane traffic occurs between at least two of the eNodeB, a serving gateway user plane function/packet data network gateway user plane function, or a serving gateway control plane function/packet data network gateway control plane function that controls the serving gateway user plane function/packet data network gateway user plane function.

11. The method of claim 8, wherein the device identities comprise an international mobile equipment identity or a subscription permanent identifier, and wherein the subscriber identities comprise an international mobile subscriber identity.

12. The method of claim 8, wherein the interface-located firewall is configured via firewall rules to determine, based on the data communications of the user equipment via the interface, if the user equipment should be blocked from communicating with the mobility network.

13. The method of claim 12, wherein in response to determining that the user equipment should be blocked from communicating with the mobility network, the interface-located firewall reports a device identifier associated with the user equipment to a scrubbed IP domain service that controls the interface-located firewall.

14. The method of claim 13, wherein the scrubbed IP domain service obtains the packet forwarding control protocol messages associated with the interface, and wherein the scrubbed IP domain service sends firewall rules to the interface-located firewall to control the interface-located firewall.

15. A computer storage medium having computer-executable instructions stored thereon that, when executed by a processor, cause the processor to perform operations comprising:
obtaining packet forwarding control protocol messages associated with a mobility network, the packet forwarding control protocol messages relating to data communications relating to a user equipment that is attached to the mobility network via a radio resource of the mobility network, the data communications comprising user plane traffic;
correlating the packet forwarding control protocol messages to subscriber identities or device identities to obtain correlated packet forwarding control protocol messages;
determining, based on the correlated packet forwarding control protocol messages, if the user equipment is associated with a malicious subscriber or comprises a malicious device;
in response to determining that the user equipment is associated with the malicious subscriber or comprises the malicious device, selecting an interface via which the radio resource connects to a user plane of the mobility network; and
triggering activation of an interface-located firewall on the interface to monitor data exchanged via the interface.

16. The computer storage medium of claim 15, wherein the mobility network comprises a fifth generation cellular network, wherein the interface comprises an N3interface, wherein the radio resource comprises a gNodeB, and wherein the user plane traffic occurs between at least two of the gNodeB, a user plane function, or a session management function that controls the user plane function.

17. The computer storage medium of claim 15, wherein the mobility network comprises a fourth generation cellular network, wherein the interface comprises an S1-U interface, wherein the radio resource comprises an eNodeB, and wherein the user plane traffic occurs between at least two of the eNodeB, a serving gateway user plane function/packet data network gateway user plane function, or a serving gateway control plane function/packet data network gateway control plane function that controls the serving gateway user plane function/packet data network gateway user plane function.

18. The computer storage medium of claim 15, wherein the device identities comprise an international mobile equipment identity or a subscription permanent identifier, and wherein the subscriber identities comprise an international mobile subscriber identity.

19. The computer storage medium of claim 15, wherein the interface-located firewall is configured via firewall rules to determine, based on the data communications of the user equipment via the interface, if the user equipment should be blocked from communicating with the mobility network.

20. The computer storage medium of claim 19, wherein in response to determining that the user equipment should be blocked from communicating with the mobility network, the interface-located firewall reports a device identifier associated with the user equipment to a scrubbed IP domain service that controls the interface-located firewall, wherein the scrubbed IP domain service obtains the packet forwarding control protocol messages associated with the interface, and wherein the scrubbed IP domain service sends firewall rules to the interface-located firewall to control the interface-located firewall.
